(19) United States
(12) Patent Application Publication
(10) Pub. No.: US 2022/0030508 A1
(43) Pub. Date: Jan. 27, 2022

(54) APPARATUS, METHOD, AND COMPUTER PROGRAM

(71) Applicant: NOKIA TECHNOLOGIES OY, Espoo (FI)

(72) Inventors: Wieslawa WAJDA, Keltern (DE); Christian MANNWEILER, München (DE)

(73) Assignee: NOKIA TECHNOLOGIES OY, Espoo (FI)

(21) Appl. No.: 17/299,453

(22) PCT Filed: Dec. 5, 2018
(86) PCT No.: PCT/EP2018/083613

§ 371 Date: Jun. 3, 2021

(51) Int. Cl. H04W 48/14; H04W 72/04

(52) U.S. Cl. CPC H04W 48/14; H04W 72/04

(57) ABSTRACT

An apparatus comprising: at least one processor; and at least one memory including computer program code; the at least one memory and the computer program code configured to, with the at least one processor, cause the apparatus at least to: determining (902) that availability information relating to (i) a specific resource associated with a specific network slice, (ii) a specific resource associated with a specific subnetwork and a specific network slice or (iii) a specific resource associated with a specific service and a specific network slice is to be requested by a first entity; and causing (904) a request for availability information to be sent by the first entity to a second entity.

### FIELD OF THE DISCLOSURE

The present disclosure relates to an apparatus, a method, and a computer program for exchanging availability information relating to (i) a specific resource associated with a specific network slice, (ii) a specific resource associated with a specific subnetwork and a specific network slice or (iii) a specific resource associated with a specific service and a specific network slice between user equipment and/or network management equipment.

### BACKGROUND

A communication system can be seen as a facility that enables communication sessions between two or more entities such as user terminals, base stations/access points and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet. In a wireless communication system at least a part of a communication session between at least two stations occurs over a wireless link.

A user can access the communication system by means of an appropriate communication device or terminal. A communication device of a user is often referred to as user equipment (UE) or user device. A communication device is provided with an appropriate signal receiving and transmitting apparatus for enabling communications, for example enabling access to a communication network or communications directly with other users. The communication device may access a carrier provided by a station or access point, and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture that is known as the long-term evolution (LTE) or the Universal Mobile Telecommunications System (UMTS) radio-access technology. Another example communication system is so called 5G radio or new radio (NR) access technology.

### SUMMARY

According to an aspect there is provided an apparatus comprising at least one processor and at least one memory including computer code for one or more programs, the at least one memory and the computer code configured, with the at least one processor, to cause the apparatus at least to: determine that availability information relating to (i) a specific resource associated with a specific network slice, (ii) a specific resource associated with a specific subnetwork and a specific network slice or (iii) a specific resource associated with a specific service and a specific network slice is to be requested by a first entity; and cause a request for availability information to be sent by the first entity to a second entity.

According to an aspect there is provided an apparatus comprising at least one processor and at least one memory including computer code for one or more programs, the at least one memory and the computer code configured, with the at least one processor, to cause the apparatus at least to: receive a request for availability information relating to (i) a specific resource associated with a specific network slice, (ii) a specific resource associated with a specific subnetwork and a specific network slice or (iii) a specific resource associated with a specific service and a specific network slice by a second entity from a first entity; and cause a response with availability information to be sent by the second entity to the first entity.

The availability information may comprise a probability to be available at a specific moment or time period.

The availability information may comprise a probability for the specific service to be available at a specific geographical area.

The availability information may comprise a probability to be available for a specific entity.

The availability information may comprise a moment or time period during which there is a highest probability to be available.

The availability information may comprises a moment or time period during which there is a highest probability to be available at a specific geographical area.

The availability information may comprise a moment or time period during which there is a highest probability to be available for a specific entity.

The specific resource may be at least one of a throughput, a processing power, a memory or a bandwidth.

The first entity may be a user side entity.

The first entity may be a network side entity.

The second entity may be a network side entity.

The network slice may comprise a mobile broadband slice, massive Internet of things slice, mission critical internet of things slice and/or one or more other slices.

The request for availability information may be sent to the second entity subsequently to the creation of the network slice.

The request for availability information may be received by the second entity subsequently to the creation of the specific network slice.

According to an aspect there is provided an apparatus comprising circuitry configured to: determine that availability information relating to (i) a specific resource associated with a specific network slice, (ii) a specific resource associated with a specific subnetwork and a specific network slice or (iii) a specific resource associated with a specific service and a specific network slice is to be requested by a first entity; and cause a request for availability information to be sent by the first entity to a second entity.

According to an aspect there is provided an apparatus comprising circuitry configured to: receiving a request for availability information relating to (i) a specific resource associated with a specific network slice, (ii) a specific resource associated with a specific subnetwork and a specific network slice or (iii) a specific resource associated with a specific service and a specific network slice by a second entity from a first entity; and causing a response with availability information to be sent by the second entity to the first entity.

The availability information may comprise a probability to be available at a specific moment or time period.

The availability information may comprise a probability for the specific service to be available at a specific geographical area.

The availability information may comprise a probability to be available for a specific entity.

The availability information may comprise a moment or time period during which there is a highest probability to be available.

The availability information may comprises a moment or time period during which there is a highest probability to be available at a specific geographical area.

The availability information may comprise a moment or time period during which there is a highest probability to be available for a specific entity.

The specific resource may be at least one of a throughput, a processing power, a memory or a bandwidth.

The first entity may be a user side entity.

The first entity may be a network side entity.

The second entity may be a network side entity.

The network slice may comprise a mobile broadband slice, massive Internet of things slice, mission critical internet of things slice and/or one or more other slices.

The request for availability information may be sent to the second entity subsequently to the creation of the network slice.

The request for availability information may be received by the second entity subsequently to the creation of the specific network slice.

According to an aspect there is provided an apparatus method comprising means for: determining that availability information relating to (i) a specific resource associated with a specific network slice, (ii) a specific resource associated with a specific subnetwork and a specific network slice or (iii) a specific resource associated with a specific service and a specific network slice is to be requested by a first entity; and causing a request for availability information to be sent by the first entity to a second entity.

According to an aspect there is provided apparatus method comprising means for: receive a request for availability information relating to (i) a specific resource associated with a specific network slice, (ii) a specific resource associated with a specific subnetwork and a specific network slice or (iii) a specific resource associated with a specific service and a specific network slice by a second entity from a first entity; and cause a response with availability information to be sent by the second entity to the first entity.

The availability information may comprise a probability to be available at a specific moment or time period.

The availability information may comprise a probability for the specific service to be available at a specific geographical area.

The availability information may comprise a probability to be available for a specific entity.

The availability information may comprise a moment or time period during which there is a highest probability to be available.

The availability information may comprises a moment or time period during which there is a highest probability to be available at a specific geographical area.

The availability information may comprise a moment or time period during which there is a highest probability to be available for a specific entity.

The specific resource may be at least one of a throughput, a processing power, a memory or a bandwidth.

The first entity may be a user side entity.

The first entity may be a network side entity.

The second entity may be a network side entity.

The network slice may comprise a mobile broadband slice, massive Internet of things slice, mission critical internet of things slice and/or one or more other slices.

The request for availability information may be sent to the second entity subsequently to the creation of the network slice.

The request for availability information may be received by the second entity subsequently to the creation of the specific network slice.

According to an aspect there is provided a method comprising: determining that availability information relating to (i) a specific resource associated with a specific network slice, (ii) a specific resource associated with a specific subnetwork and a specific network slice or (iii) a specific resource associated with a specific service and a specific network slice is to be requested by a first entity; and causing a request for availability information to be sent by the first entity to a second entity.

According to an aspect there is provided a method comprising: receiving a request for availability information relating to (i) a specific resource associated with a specific network slice, (ii) a specific resource associated with a specific subnetwork and a specific network slice or (iii) a specific resource associated with a specific service and a specific network slice by a second entity from a first entity; and causing a response with availability information to be sent by the second entity to the first entity.

The availability information may comprise a probability to be available at a specific moment or time period.

The availability information may comprise a probability for the specific service to be available at a specific geographical area.

The availability information may comprise a probability to be available for a specific entity.

The availability information may comprise a moment or time period during which there is a highest probability to be available.

The availability information may comprises a moment or time period during which there is a highest probability to be available at a specific geographical area.

The availability information may comprise a moment or time period during which there is a highest probability to be available for a specific entity.

The specific resource may be at least one of a throughput, a processing power, a memory or a bandwidth.

The first entity may be a user side entity.

The first entity may be a network side entity.

The second entity may be a network side entity.

The network slice may comprise a mobile broadband slice, massive Internet of things slice, mission critical internet of things slice and/or one or more other slices.

The request for availability information may be sent to the second entity subsequently to the creation of the network slice.

The request for availability information may be received by the second entity subsequently to the creation of the specific network slice.

According to an aspect there is provided a computer program comprising computer executable code which when run on at least one processor is configured to determine that availability information relating to (i) a specific resource associated with a specific network slice, (ii) a specific resource associated with a specific subnetwork and a specific network slice or (iii) a specific resource associated with a specific service and a specific network slice is to be requested by a first entity; and cause a request for availability information to be sent by the first entity to a second entity.

According to an aspect there is provided a computer program comprising computer executable code which when run on at least one processor is configured to receive a request for availability information relating to (i) a specific resource associated with a specific network slice, (ii) a specific resource associated with a specific subnetwork and a specific network slice or (iii) a specific resource associated with a specific service and a specific network slice by a second entity from a first entity; and cause a response with availability information to be sent by the second entity to the first entity.

The availability information may comprise a probability to be available at a specific moment or time period.

The availability information may comprise a probability for the specific service to be available at a specific geographical area.

The availability information may comprise a probability to be available for a specific entity.

The availability information may comprise a moment or time period during which there is a highest probability to be available.

The availability information may comprises a moment or time period during which there is a highest probability to be available at a specific geographical area.

The availability information may comprise a moment or time period during which there is a highest probability to be available for a specific entity.

The specific resource may be at least one of a throughput, a processing power, a memory or a bandwidth.

The first entity may be a user side entity.

The first entity may be a network side entity.

The second entity may be a network side entity.

The network slice may comprise a mobile broadband slice, massive Internet of things slice, mission critical internet of things slice and/or one or more other slices.

The request for availability information may be sent to the second entity subsequently to the creation of the network slice.

The request for availability information may be received by the second entity subsequently to the creation of the specific network slice.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### List of Abbreviations

CN: Core Network

CSCF: Communication Service Customer Function

CSMF: Communication Service Management Function

IoT: Internet of Things

LTE: Long Term Evolution

M: Mandatory

MTC: Machine Type Communication

MS: Mobile Station

NF: Network Function

NR: New Radio

NRAEF: Network Resource Availability Estimation Function

NSI: Network Slice Instance

NSSI: Network Slice Subnet Instance

O: Optional

PDA: Personal Digital Assistant

RAM: Random Access Memory

ROM: Read Only Memory

UE: User Equipment

UMTS: Universal Mobile Telecommunication System

USB: Universal Serial Bus

UTRAN: Universal Terrestrial Radio Access Network

VoIP: Voice over IP

3G: 3^{rd} Generation

4G: 4^{th} Generation

5G: 5^{th} Generation

### BRIEF DESCRIPTION OF THE FIGURES

Embodiments will now be described, by way of example only, with reference to the accompanying Figures in which:

FIG. 1 shows a schematic representation of a communication system;

FIG. 2 shows a schematic representation of a control apparatus;

FIG. 3 shows a schematic representation of a user equipment;

FIG. 4a shows a schematic representation of network slices of a network;

FIG. 4b shows a schematic representation of one of the network slices of FIG. 4a;

FIG. 5 shows a schematic representation of the environment of a network resource availability estimation function;

FIG. 6 shows a schematic representation of a method for communicating availability information relating to a specific service associated with a network slice;

FIG. 7 shows a schematic representation of another method for communicating availability information relating to a specific service associated with a network slice;

FIG. 8 shows a schematic representation of a method for communicating availability information relating to a specific resource associated with a network slice;

FIG. 9 shows a schematic representation of a method for receiving availability information relating to a specific service or a specific resource associated with a network slice;

FIG. 10 shows a schematic representation of a method for sending availability information relating to a specific service or a specific resource associated with a network slice; and

FIG. 11 shows a schematic representation of a non-volatile memory medium storing instructions which when executed by a processor allow a processor to perform one or more of the steps of the method of any of FIGS. 6 to 10.

### DETAILED DESCRIPTION OF THE FIGURES

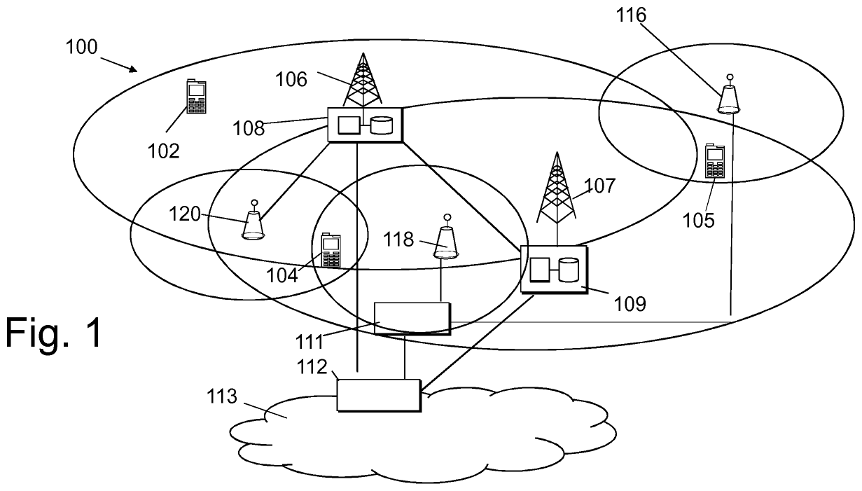

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1 to 3 to assist in understanding the technology underlying the described examples.

FIG. 1 illustrates an example of a wireless communication system 100. The wireless communication system 100 comprises wireless communication devices 102, 104, 105. The wireless communication devices 102, 104, 105 are provided wireless access via at least one base station 106 and 107 or similar wireless transmitting and/or receiving node or point. Base stations 106 and 107 are typically controlled by at least one appropriate control apparatus. The controller apparatus may be part of the base stations 106 and 107 or external to the base stations 106 and 107.

Base stations 106 and 107 are connected to a wider communications network 113 via a gateway 112. A further gateway may be provided to connect to another network.

Base stations 116, 118 and 120 associated with smaller cells may also be connected to the network 113, for example by a separate gateway and/or via the macro level stations. The base stations 116, 118 and 120 may be pico or femto level base stations or the like. In the example, base stations 116 and 118 are connected via a gateway 111 whilst base station 120 connects via the base station 106. In some embodiments, the smaller base stations 116, 118 and 120 may not be provided.

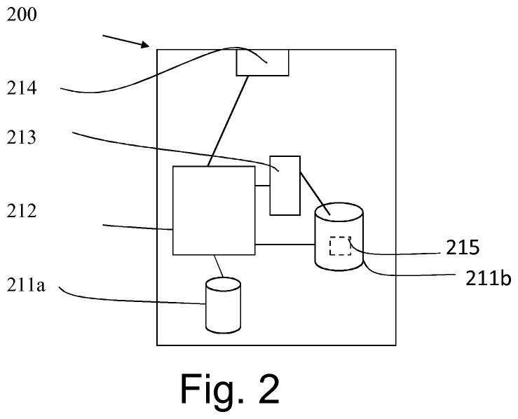

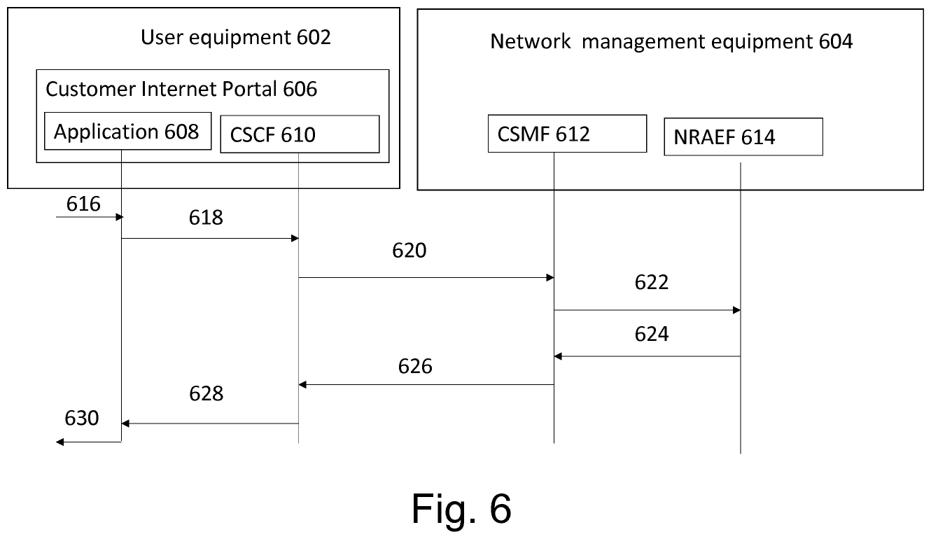

FIG. 2 illustrates an example of a control apparatus 200 for a node, for example to be integrated with, coupled to and/or otherwise for controlling a base station, such as the base station 106, 107, 116, 118 or 120 shown on FIG. 1. The control apparatus 200 can be arranged to allow communications between a user equipment and a core network. For this purpose the control apparatus comprises at least one random access memory (RAM) 211a and at least on read only memory (ROM) 211b, at least one processor 212, 213 and an input/output interface 214. The at least one processor 212, 213 is coupled to the RAM 211a and the ROM 211b. Via the interface the control apparatus 200 can be coupled to relevant other components of the base station. The at least one processor 212, 213 may be configured to execute an appropriate software code 215. The software code 215 may for example allow to perform one or more steps of a method according to any of FIGS. 6 to 10. The software code 215 may be stored in the ROM 211b. It shall be appreciated that similar components can be provided in a control apparatus provided elsewhere in the network system, for example in a core network (CN) entity. The control apparatus 200 can be interconnected with other control entities. In some embodiments, each base station can comprise a control apparatus. In alternative embodiments, two or more base stations may share a control apparatus.

Base stations and associated controllers may communicate with each other via a fixed line connection and/or via a radio interface. The logical connection between the base stations can be provided for example by an X2 or the like interface. This interface can be used for example for coordination of operation of the base stations and performing reselection or handover operations.

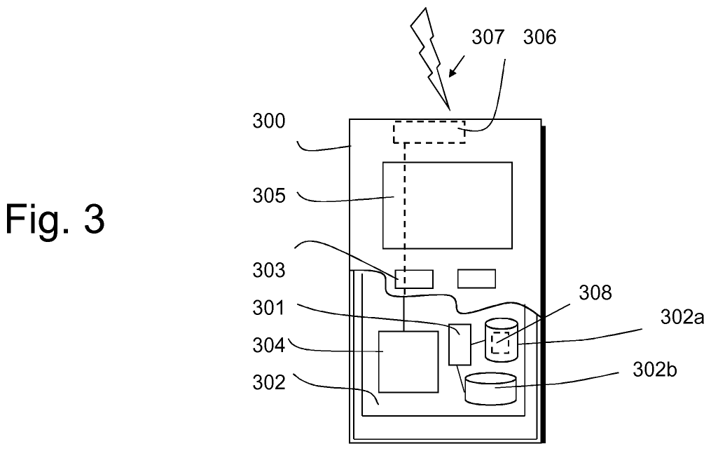

FIG. 3 illustrates an example of a user equipment or wireless communication device 300, such as the wireless communication device 102, 104 or 105 shown on FIG. 1. The wireless communication device 300 may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, machine-type communications (MTC) devices, IoT type communication devices or any combinations of these or the like. A device may provide, for example, communication of data for carrying communications. The communications may be one or more of voice, electronic mail (email), text message, multimedia, data, machine data and so on.

The device 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The wireless communication device 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 211a and the ROM 211b. The at least one processor 301 may be configured to execute an appropriate software code 308. The software code 308 may for example allow to perform one or more steps of a method according to any of FIGS. 6 to 10. The software code 308 may be stored in the ROM 211b.

The processor, storage and other relevant control apparatus can be provided on an appropriate circuit board and/or in chipsets. This feature is denoted by reference 304. The device may optionally have a user interface such as key pad 305, touch sensitive screen or pad, combinations thereof or the like. Optionally one or more of a display, a speaker and a microphone may be provided depending on the type of the device.

One or more of the following examples relate to 5G systems but it will be understood that these examples may apply to other radio access technology systems.

5G systems are designed to be more flexible than 4G systems. 5G systems are designed to support customers' requirements as well as service providers' requirements.

A single 5G physical network may be sliced into multiple virtual networks (i.e. network slices). Each network slice may be associated with one or more respective resources. Each network slice may be associated with one or more respective services. Each network slice may comprise one or more logical network functions that provide the resources and support the services requirements. Each network slice may be managed and/or configured independently.

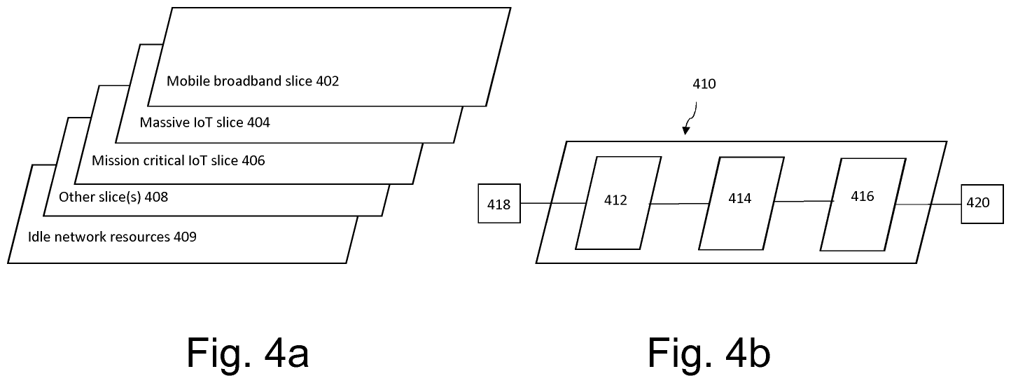

FIG. 4a shows a schematic representation of an example of a physical network sliced into multiple virtual networks (i.e. network slices). The network slices may comprise a mobile broadband slice 402, a massive Internet of Things (IoT) slice 404, a mission critical IoT slice 406 and/or one or more other slices 408. The physical network may comprise idle network resources 409 (i.e. resources that are not allocated to any network slice).

FIG. 4b shows a schematic representation a network slice 410. The network slice 410 comprises one or more subnetworks 412, 414 and 418. The subnetwork 412 may be a radio subnetwork. The subnetwork 414 may be a transport subnetwork. The subnetwork 416 may be a core subnetwork. The subnetwork 412 may be connected to one or more user equipment 418. The subnetwork 416 may be connected to one or more server equipment 420.

The mobile broadband slice 402 may be associated with communication services, entertainment services and/or Internet services. The massive IoT slice 404 may be associated with retail services, shipping services, logistics services, agriculture services, climate services and/or manufacturing services. The mission critical IoT slice 406 may be associated with automotive services, medical services and/or infrastructure services. The one or more other slices 408 may be associated with one or more other services.

A challenge of network slicing may be the provision of independent business operations on a common physical network in an efficient and economical way. Another challenge may be to enable customers and/or service providers to adequately estimate resource availability/usage at a specific moment (e.g. date and/or time) or time period in the future. Another challenge may be to allow customers and/or service providers to adequately estimate a service availability at a specific moment (e.g. date and/or time) or time period in the future.

As these challenges are currently not being addressed a physical network may not be economically viable because the physical network is inefficiently utilized. In addition, from the service provider's point of view, services may suffer from low differentiation which leads to lower margins. From the customer's point of view, personalised services may not be provided.

3GPP's technical specification TS 28.531 is concerned with network slicing provisioning. It describes the use case “Network Slice feasibility check” and “Network slice subnet feasibility check” to check the feasibility of provisioning a network slice instance (including network slice constituents) and to determine whether network slice instance requirements can be satisfied (e.g. in terms of resources). If slice provisioning is not feasible, the slice cannot be created. The feasibility check is done only when the slice is to be created. No feasibility check is done after the slice is created, let alone a feasibility check directed to a specific service associated with a network slice or a specific resource associated with a network slice.

One or more of the following examples relates to functions for estimating availability of (i) a specific resource associated with a specific network slice, (ii) a specific resource associated with a specific subnetwork and a specific network slice or (iii) a specific resource associated with a specific service and a specific network slice.

These functions may be achieved by providing one or more network functions such as a Network Resource Availability Estimation Function (NRAEF) and/or one or more new messages.

A request for an estimation of availability of a specific resource associated with a specific service and a specific network slice may concern the availability of some or all resources associated with the specific network slice necessary for the specific service instantiation.

Various service resources may need to be guaranteed by a network slice when the service is running. The request may be a complex request and may be broken down into a plurality of specific service resource.

The sender of the request for estimation of availability of a specific service associated with a network slice may be a user side function, such as a Communication Service Customer Function (CSCF). The user side function may be part of an Internet portal. The user side function may be installed on a user equipment.

The receiver of the request for estimation of availability of a specific resource associated with a specific service and a specific network slice may be a network side function, such as a Communication Service Management side function (CSMF) and/or the NRAEF. The network side function may be installed one or more network management equipment such as service provider network management equipment.

The request for estimation of availability of a specific resource associated with a specific network slice may concerns throughput, processing power, memory, bandwidth, frequency and/or other resources.

The sender of the request for estimation of availability of a specific resource associated with a specific network slice may be any authorized network side function.

The receiver of the request for estimation of availability of a specific resource associated with a specific network slice may be a network side function such as the NRAEF.

The NRAEF may installed on one or more network management equipment which may have access to some or all of the physical network and/or virtual network information. Network management equipment in different physical networks and/or virtual networks and public land mobile network domains may exchange information.

The NRAEF may compute a response to the request for estimation of availability of a specific resource associated with a specific service and a specific network slice and/or the request for estimation of availability of a specific resource associated with a specific network slice based on one or more parameters. The parameters may comprise physical network parameters and/or virtual network parameters. The parameters may comprise performance parameters, traffic prognosis parameters, fault parameters, calendar data parameters, policies parameters, business parameters and/or other parameters.

The performance parameters may comprise latency (e.g. backhaul link rate, buffer size, interleaving), jitter (e.g. shaping), packet loss (e.g. shaping, buffer size), activity factor, bandwidth (e.g. per interface/number of users per interface, per user), area traffic capacity, pick bandwidth (e.g. aggregation link peak capacity), throughput, utilization, key performance indicator (e.g. availability, accessibility, reliability, redundancy, survival time), coverage, connectivity, radio technology and/or traffic characteristics.

The traffic prognosis parameters may comprise statistical traffic profile, expected traffic profile, environmental changes and/or network planning.

It will be understood that other parameters may be used alternatively or additionally to the above listed parameters.

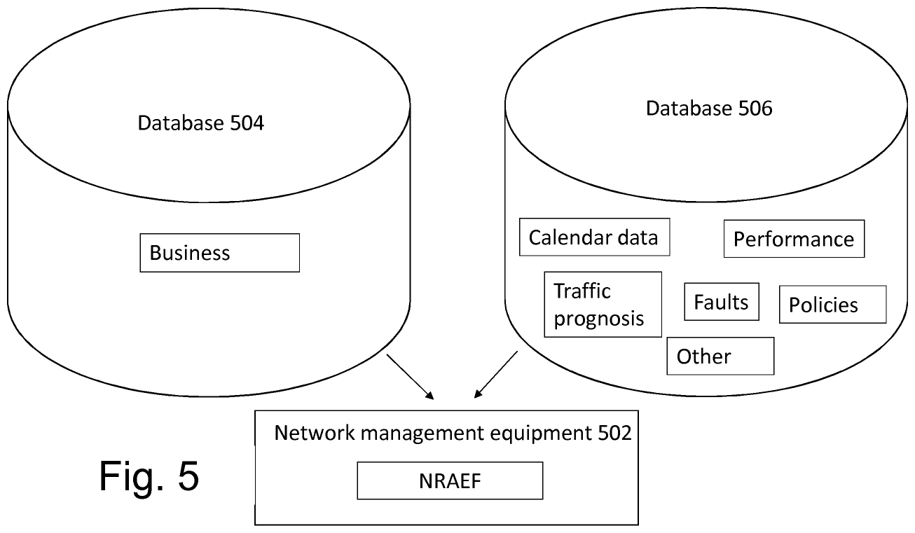

FIG. 5 shows a schematic representation of the environment of a NRAEF. One or more network management equipment 502 may comprise the NRAEF. The network management equipment 502 may be a service provider network management equipment. The network management equipment 502 may be connected to a database 504 and a database 506. The database 504 may store business parameters. The database 506 may store performance parameters, traffic prognosis parameters, fault parameters, calendar data parameters, policies parameters or other parameters.

With regard to the request for estimation of availability of a specific resource associated with a specific service and a specific network slice, the involved equipment may comprise a user equipment and one or more network management equipment.

A customer and/or a service provider may have the possibility to get information about the probability of successful service instantiation in the future. Such information may be helpful for business comparison and/or business planning. Based on the information, the customer and/or the service provider may calculate business alternatives and/or make profitability analyses.

The customer and/or the service provider may request different types of information. The first type of information may be the probability that a specific service associated with a network slice may be successfully instantiated presently or in the future. The second type of information may be the best possible moment (e.g. date and/or time) for a specific service associated with a network slice to be successfully instantiated presently or in the future.

The request for estimation of availability of a specific resource associated with a specific service and a specific network slice may be implemented by sending and/or receiving the following messages to and from the NRAEF.

A message getSERVICE_AVAILABILITY_PROBABILITY(attributes) may request the probability that a specific service will be successfully instantiated presently or in the future. In this case, the availability of all resources associated with a network slice required to successfully instantiate the specific service may be checked by the NRAEF.

A message getBEST_SERVICE_AVAILABILITY_PROBABILITY(attributes) may request the moment (e.g. date and/or time) or time period for which there is the highest probability for a specific service associated with a network slice to be successfully instantiated presently or in the future.

FIG. 6 shows a schematic representation of a method for communicating availability information relating to a specific resource associated with a specific service and a specific network slice. The method may be performed by a user equipment 602 and one or more network management equipment 604.

The user equipment 602 may comprise a customer Internet portal 606. The customer Internet portal 606 may comprise an application function 608 and a CSCF 610. It will be understood that in some implementation the CSCF 610 may be part of the network management equipment 604.

The network management equipment 604 may be a service provider network management equipment. The network management equipment 604 may comprise a CSMF 612 (defined in 3GPP TR 28.801) and a NRAEF 614.

In step 616, the application function 608 may receive a third party request for availability information relating to a specific resource associated with a specific service and a specific network slice. For example, the third party may be a customer or a service provider's operator. The application function 608 may receive the third party request via a graphic user interface or the like.

In step 616, the application function 608 may forward the third party request to the CSCF 610.

In step 620, the CSCF 610 may translate the third party request into a getSERVICE_AVAILABILITY_PROBABILITY (attributes) message and may send the getSERVICE_AVAILABILITY_PROBABILITY (attributes) message to the CSMF 612. The attributes of the getSERVICE_AVAILABILITY_PROBABILITY (attributes) message may comprise one or more of the following.

TABLE 1
Attributes of
getSERVICE_AVAILABILITY_PROBABILITY
(attributes) message

| Information | | | Qual- | |
|---|---|---|---|---|
| element | Definition | Content | ifier | Description |
| Requested | Identifier | numerical value | M | Reference to the |
| Entity, e.g. | | (e.g. integer, | | entity which |
| customer | | double, etc.) | | requires the |
| | | | | information |
| Service, | Identifier | numerical value | M | Service Identifier |
| e.g. VoIP | | (e.g. integer, | | for which the |
| | | double, etc.) | | availability |
| | | | | estimation is |
| | | | | required |
| Location | List of | area defined by | O | Area definition |
| | geo- | polygon and | | for which the |
| | graphical | coordinates | | service |
| | coordinates | | | availability |
| | | | | estimation is |
| | | | | required |
| | | | | (usually |
| | | | | provided by a |
| | | | | customer |
| | | | | and/or service |
| | | | | provider |
| Slice | Identifier | numerical value | M | Slice identifier |
| | | (e.g. integer, | | associated with |
| | | double, etc.) | | the service |
| Time | Date and | List of se- | M | Date/Time on |
| | Time | quence <{nu- | | which the |
| | | merical value | | service should |
| | | (e.g. integer, | | be running. |
| | | double, etc.) of | | Periodic or |
| | | attribute pairs}, | | aperiodic |
| | | {date, time}> | | duration of the |
| | | | | service is |
| | | | | possible. |

It will be understood that although in TABLE 1 all the attributes are indicated as mandatory (M) some of these attributes may be optional (O).

In step 622, the CSMF 612 may forward the getSERVICE_AVAILABILITY_PROBABILITY (attributes) message to the NRAEF 614.

In step 624, the NRAEF 614 may compute a postSERVICE_AVAILABILITY_PROBABILITY (attributes) message based on the parameters discussed above in reference to FIG. 5. The attributes of the postSERVICE_AVAILABILITY_PROBABILITY (attributes) message may comprise one or more of the following.

TABLE 2
Attributes of
postSERVICE_AVAILABILITY_PROBABILITY
(attributes) message

| Information | | | Qual- | |
|---|---|---|---|---|
| element | Definition | Content | ifier | Description |
| Requested | Identifier | numerical value | M | Reference to the |
| Entity, e.g. | | (e.g. integer, | | entity which |
| customer | | double, etc.) | | requires the |
| | | | | information |
| Service, | Identifier | numerical value | M | Service Identifier |
| e.g. VoIP | | (e.g. integer, | | for which the |
| | | double, etc.) | | availability |
| | | | | estimation was |
| | | | | required |
| Slice | Identifier | numerical value | M | Slice identifier |
| | | (e.g. integer, | | associated with |
| | | double, etc.) | | the service |
| Service | Service | integer | M | Describes in [%] |
| probability | availability | | | instantiation |
| | probability | | | probability of the |
| | | | | specified service. |

It will be understood that although in TABLE 2 all the attributes are indicated as mandatory (M) some of these attributes may be optional (O).

In step 626, the CSMF 612 may forward the postSERVICE_AVAILABILITY_PROBABILITY (attributes) message to the CSCF 610.

In step 628, the CSCF 610 may translate the postSERVICE_AVAILABILITY_PROBABILITY (attributes) message into a user response and may send the user response to the application function 608.

In step 630, the application function 608 may output the user response to the user via the graphical user interface or the like.

It will be understood that in TABLE 1 and TABLE 2, through the Service Identifier, some or all resources for a service may be predefined. As a result no detailed list of resources may need to be specified in the getSERVICE_AVAILABILITY_PROBABILITY (attributes) message or the getBEST_SERVICE_PROBABILITY (attributes) message. Based on the Service Identifier, these messages which form a complex request may be broken down by the CSMF or the NRAEF into a plurality of specific service resources. The Service Identifier with associated set of resources may be stored in a database for network management access.

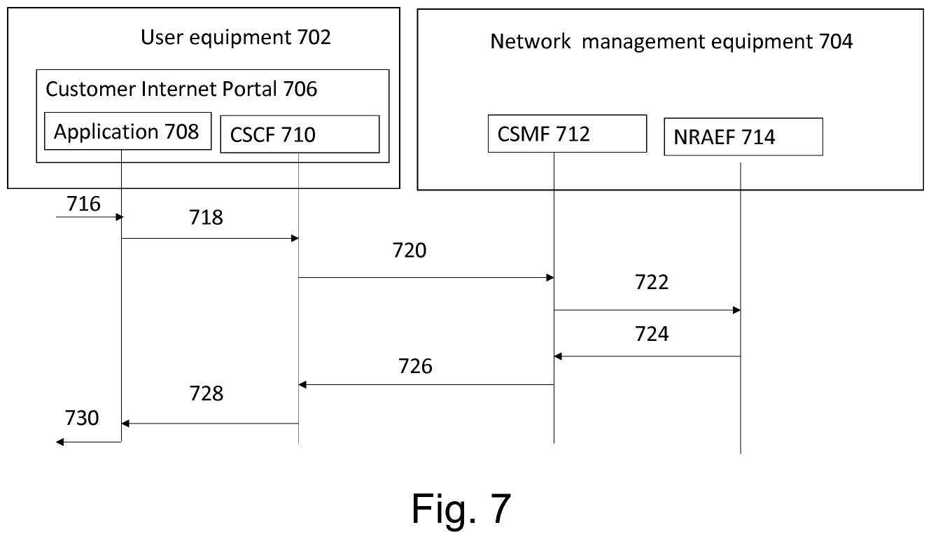

FIG. 7 shows a schematic representation of another method for communicating availability information relating to a specific resource associated with a specific service and a network slice. The method may be performed by a user equipment 702 and one or more network management equipment 704.

The user equipment 702 may comprise a customer Internet portal 706. The customer Internet portal 706 may comprise an application function 708 and a CSCF 710. It will be understood that in some implementation the CSCF 710 may be part of the network management equipment 704.

The network management equipment 704 may be a service provider network management equipment. The network management equipment 704 may comprise a CSMF 712 and a NRAEF 714.

In step 716, the application function 708 may receive a third party request for availability information relating to a specific service associated with a network slice. For example, the third party may be a customer or a service provider's operator. The application function 708 may receive the user request via a graphic user interface or the like.

In step 716, the application function 708 may forward the third party request to the CSCF 710.

In step 720, the CSCF 710 may translate the user request into a getBEST_SERVICE_PROBABILITY (attributes) message and may send the getBEST_SERVICE_PROBABILITY (attributes) message to the CSMF 712. The attributes of the getBEST_SERVICE_PROBABILITY (attributes) message may comprise one or more of the following.

TABLE 3
Attributes of
getBEST_SERVICE_AVAILABILITY_PROBABILITY
(attributes) message

| Information | | | Qual- | |
|---|---|---|---|---|
| element | Definition | Content | ifier | Description |
| Requested | Identifier | numerical value | M | Reference to the |
| Entity, e.g. | | (e.g. integer, | | entity which |
| customer | | double, etc.) | | requires the |
| | | | | information |
| Service, | Identifier | numerical value | M | Service Identifier |
| e.g. VoIP | | (e.g. integer, | | for which the |
| | | double, etc.) | | availability |
| | | | | estimation is |
| | | | | required |
| Slice | Identifier | numerical value | M | Slice identifier |
| | | (e.g. integer, | | associated with |
| | | double, etc.) | | the service |
| Location | List of | area defined by | O | Area definition |
| | geo- | polygon and | | for which the |
| | graphical | coordinates | | service |
| | coordinates | | | availability |
| | | | | estimation is |
| | | | | required |
| | | | | (usually |
| | | | | provided by a |
| | | | | customer |
| | | | | and/or service |
| | | | | provider |
| Tracking | List of | sequence of | O | Tracking area |
| area | identifiers | tracking area | | identifiers list |
| identifiers | | identifiers | | (usually |
| list | | | | provided by |
| | | | | the physical |
| | | | | network |
| | | | | operator) |

It will be understood that although in TABLE 3 some of the attributes are indicated as mandatory (M), these attributes may be optional (O).

In step 722, the CSMF 712 may forward the getBEST_SERVICE_PROBABILITY (attributes) message to the NRAEF 714.

In step 724, the NRAEF 714 may compute a postBEST_SERVICE_PROBABILITY (attributes) message based on the parameters discussed above in reference to FIG. 5.

The attributes of the postBEST_SERVICE_PROBABILITY (attributes) message may comprise one or more of the following.

TABLE 4
Attributes of
postBEST_SERVICE_AVAILABILITY_PROBABILITY
(attributes) message

| | | | Qual- | |
|---|---|---|---|---|
| Information | Definition | Content | ifier | Description |
| Requested | Identifier | numerical value | M | Reference to the |
| Entity, e.g. | | (e.g. integer, | | entity which |
| customer | | double, etc.) | | required the |
| | | | | information |
| Service, | Identifier | numerical value | M | Service identifier |
| e.g. VoIP | | (e.g. integer, | | for which the |
| | | double, etc.) | | availability |
| | | | | estimation is |
| | | | | required |
| Slice | Identifier | numerical value | M | Slice identifier |
| | | (e.g. integer, | | associated with |
| | | double, etc.) | | the service |
| Time | Date and | List of se- | M | Date/Time for |
| | Time | quence <{nu- | | which the |
| | period | mber of | | probability [in %] |
| | | attribute pairs}, | | of service |
| | | [{date, time}, | | instantiation |
| | | {probability}]> | | is highest. |
| | | | | Periodic or |
| | | | | aperiodic time |
| | | | | and date |
| | | | | indications are |
| | | | | possible. |

It will be understood that although in TABLE 4 all the attributes are indicated as mandatory (M) some of these attributes may be optional (O).

In step 726, the CSMF 712 may forward the postSERVICE_AVAILABILITY_PROBABILITY (attributes) message to the CSCF 710.

In step 728, the CSCF 710 may translate the postSERVICE_AVAILABILITY_PROBABILITY (attributes) message into a user response and may send the user response to the application function 708.

In step 730, the application function 708 may output the user response to the user via the graphical user interface or the like.

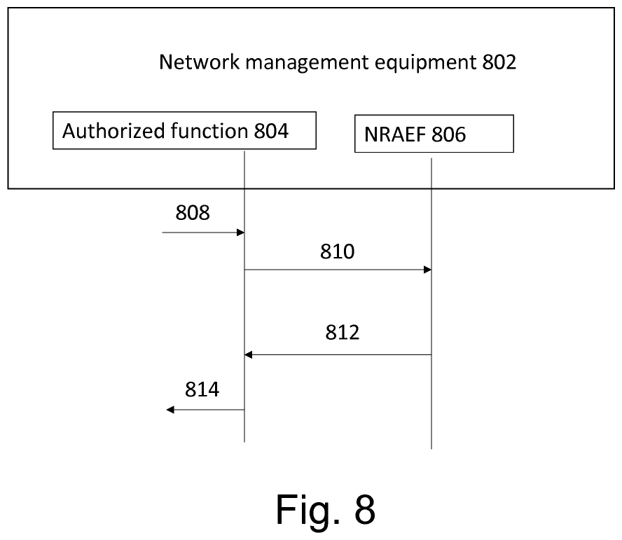

FIG. 8 shows a schematic representation of a method for communicating availability information relating to a specific resource associated with a network slice. The method may be performed by one or more network management equipment 802.

The network management equipment 8002 may be a service provider network management equipment. The network management equipment 802 may comprise an authorized function 804 and a NRAEF 806. The authorized function 804 may be a network management planning function, a network data analytics function or another function.

In step 808, the authorized function 804 may receive a trigger to send a getRESOURCE_AVAILABILITY_PROBABILITY (attributes) message to the NRAEF 806.

In step 810, the authorized function 804 may send the getRESOURCE_AVAILABILITY_PROBABILITY (attributes) message to the NRAEF 806.

The attributes of the getRESOURCE_AVAILABILITY_PROBABILITY (attributes) message may comprise one or more of the following.

TABLE 5
Attributes of
getRESOURCE_SERVICE_AVAILABILITY_PROBABILITY
(attributes) message

| Information | | | Qual- | |
|---|---|---|---|---|
| element | Definition | Content | ifier | Description |
| Requested | Identifier | numerical value | M | Reference to the |
| Entity/NF | | (e.g. integer, | | entity which |
| | | double, etc.) | | requires the |
| | | | | information |
| Location | List of | area defined by | O | Area definition |
| | geo- | polygon and | | for which the |
| | graphical | coordinates | | service |
| | coordinates | | | availability |
| | | | | estimation is |
| | | | | required |
| | | | | (usually |
| | | | | provided by a |
| | | | | customer |
| | | | | and/or service |
| | | | | provider |
| Slice | Identifier | numerical value | M | Slice identifier |
| | | (e.g. integer, | | associated with |
| | | double, etc.) | | the service |
| Time | Date and | List of se- | M | Date/Time on |
| | Time | quence <{nu- | | which the |
| | | mber of | | resource is |
| | | attribute pairs}, | | needed. |
| | | {date, time}> | | Periodic or |
| | | | | aperiodic time |
| | | | | duration can be |
| | | | | specified. |
| Resource | Throughput, | List of | M | One or more |
| | CPU, | attributes | | attributes can |
| | Storage, | | | be defined |
| | Memory, | | | |
| | Bandwidth | | | |
| Constrains | e.g. license | http link | O | Constrains to be |
| | | | | considered |

It will be understood that although in TABLE 5 most attributes are indicated as mandatory (M) these attributes may be optional (O).

It will also be understood that the listed resources are not exhaustive and other resources may be specified.

It will also be understood that, as for the Service Identifier, the resources are not necessary explicitly listed. A complex identifier (e.g. traffic profile identifier) may be predefined to refer to a set of specific resources.

In step 812, the NRAEF 806 may compute a postRESOURCE_SERVICE_AVAILABILITY_PROBABILITY (attributes) message based on the parameters discussed above in reference to FIG. 5. The attributes of the postRESOURCE_SERVICE_AVAILABILITY_PROBABILITY (attributes) message may comprise one or more of the following.

TABLE 6
Attributes of
postRESOURCE_SERVICE_AVAILABILITY_PROBABILITY
(attributes) message

| Information | | | Qual- | |
|---|---|---|---|---|
| element | Definition | Content | ifier | Description |
| Requested | Identifier | numerical value | M | Reference to the |
| Entity/NF | | (e.g. integer, | | entity which |
| | | double, etc.) | | requires the |
| | | | | information |
| Slice | Identifier | numerical value | M | Slice identifier |
| | | (e.g. integer, | | associated with |
| | | double, etc.) | | the service |
| Probability | Date and | List of se- | M | Date/Time, |
| | Time | quence <{nu- | | resource, free |
| | | mber of | | resource |
| | | attribute pairs}, | | availability |
| | | [{date, time}, | | probability. |
| | | {resource, | | |
| | | probability}]> | | |

It will be understood that although in TABLE 6 all the attributes are indicated as mandatory (M) some of these attributes may be optional (O).

In step 814, the authorize function 804 may output the postRESOURCE_SERVICE_AVAILABILITY_PROBABILITY (attributes) message.

One or more of the above examples allow enhanced network slicing and network management. Moreover, the operator may adequately plan network utilization and usage of network resource at specific date and time. Therefore, the network may be economically viable. This may lead to increasing profit, additional business opportunities and increased differentiation between operators. Third parties (e.g. service provider) may plan their business and offer new services to their customers. The possibility for estimation for resource availability for short term, medium term, long term, periodic and/or aperiodic services allows service providers calculation of business alternatives and allows profitability analysis. Personalised services will therefore be possible.

It will be understood that although in the above embodiments the defined messages relate to requesting availability information relating to a specific resource associated with a network slice and requesting availability information relating to a specific resource associated with a specific service and a specific network slice, similar messages may be defined for requesting availability information for a specific resource associated with a specific subnetwork and a specific network slice.

It will also be understood that the message defined above may be replaced by alternative messages, such as:

get_WORST_RESOURCE_AVAILABILITY;

post_WORST_RESOURCE_AVAILABILITY;

get_SERVICE_UNAVAILABILITY_PROBABILITY;

post_SERVICE_UNAVAILABILITY_PROBABILITY;

get_RESOURCE_UNAVAILABILITY_PROBABILITY;

post_RESOURCE_UNAVAILABILITY_PROBABILITY.

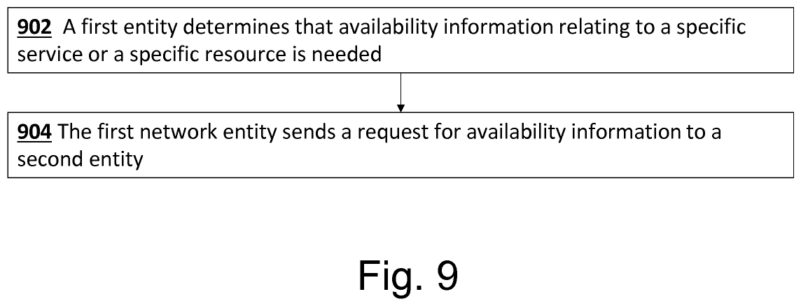

FIG. 9 shows a schematic representation of a method for receiving availability information relating to a specific service or a specific resource associated with a network slice.

In step 902, a first entity (i.e. function) may determine that availability information relating to a specific service or a specific resource is needed.

In step 904, the first entity may send at least one request for availability information to a second entity. The request may be sent to the second entity subsequently to the creation of a network slice associated with the specific service or with the specific resource. In this way, unlike TS28 28.531 a feasibility check is performed for the specific service or for the specific resource after the creation of a network slice.

The request may comprise a getSERVICE_AVAILABILITY_PROBABILITY (attributes) message, a getBEST_SERVICE_AVAILABILITY_PROBABILITY (attributes) message or a getRESOURCE_AVAILABILITY_PROBABILITY (attributes) message.

In an implementation, the method may be performed at least in part at a user equipment. The first entity may be a CSCF and the second entity may be a CSMF as shown on FIGS. 6 and 7.

In another implementation the method may be performed at least in part at one or more network management equipment. The first entity may be a CSMF or any authorized network entity and the second entity may be a NRAEF as shown on FIGS. 6, 7 and 8.

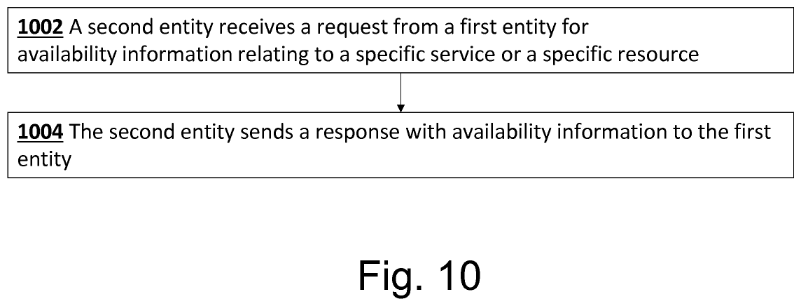

FIG. 10 shows a schematic representation of a method for sending availability information relating to a specific service or a specific resource associated with a network slice.

In step 1002, a second entity (i.e. function) may receive a request for availability information from a first entity. The request may be received subsequently to the creation of a network slice associated with the specific service or with the specific resource. In this way, unlike TS28 28.531 a feasibility check is performed for the specific service or for the specific resource after the creation of the network slice.

The request may comprise a getSERVICE_AVAILABILITY_PROBABILITY (attributes) message, a getBEST_SERVICE_AVAILABILITY_PROBABILITY (attributes) message or a getRESOURCE_AVAILABILITY_PROBABILITY (attributes) message.

In step 1004, the second entity may send a response with availability information to the first entity.

The response may comprise a postSERVICE_AVAILABILITY_PROBABILITY (attributes) message, a postBEST_SERVICE_AVAILABILITY_PROBABILITY (attributes) message or a postRESOURCE_AVAILABILITY_PROBABILITY (attributes) message.

In an implementation, the method may be performed at least in part at a user equipment. The first entity may be a CSCF and the second entity may be a CSMF as shown on FIGS. 6 and 7.

In another implementation the method may be performed at least in part at one or more network management equipment. The first entity may be a CSMF or any authorized network entity and the second entity may be a NRAEF as shown on FIGS. 6, 7 and 8.

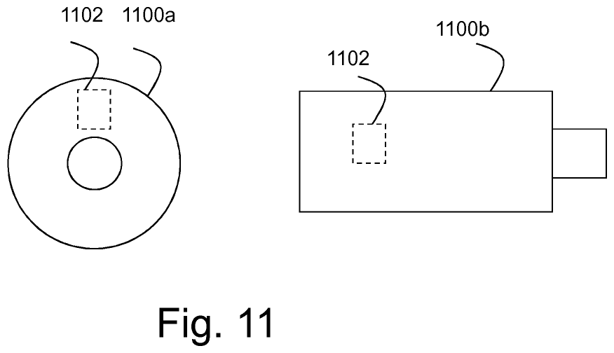

FIG. 11 shows a schematic representation of non-volatile memory media 1100a (e.g. computer disc (CD) or digital versatile disc (DVD)) and 1100b (e.g. universal serial bus (USB) memory stick) storing instructions and/or parameters 1102 which when executed by a processor allow the processor to perform one or more of the steps of the methods of FIGS. 6 to 10.

It is noted that while the above describes example embodiments, there are several variations and modifications which may be made to the disclosed solution without departing from the scope of the present invention.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 6 to 10, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising:
at least one processor; and
at least one memory including computer program code;
the at least one memory and the computer program code configured to, with the at least one processor, cause the apparatus at least to:
determine that availability information relating to (i) a specific resource associated with a specific network slice, (ii) a specific resource associated with a specific subnetwork and a specific network slice or (iii) a specific resource associated with a specific service and a specific network slice is to be requested by a first entity; and
cause a request for availability information to be sent by the first entity to a second entity.

2. An apparatus comprising:
at least one processor; and
at least one memory including computer program code;
the at least one memory and the computer program code configured to, with the at least one processor, cause the apparatus at least to:
receive a request for availability information relating to (i) a specific resource associated with a specific network slice, (ii) a specific resource associated with a specific subnetwork and a specific network slice or (iii) a specific resource associated with a specific service and a specific network slice by a second entity from a first entity; and
cause a response with availability information to be sent by the second entity to the first entity.

3. An apparatus according to claim 1, wherein the availability information comprises a probability to be available at a specific moment or time period.

4. An apparatus according to claim 1, wherein the availability information comprises a probability for the specific service to be available at a specific geographical area.

5. An apparatus according to claim 1, wherein the availability information comprises a probability to be available for a specific entity.

6. An apparatus according to claim 1, wherein the availability information comprises a moment or time period during which there is a highest probability to be available.

7. An apparatus according to claim 6, wherein the availability information comprises a moment or time period during which there is a highest probability to be available at a specific geographical area.

8. An apparatus according to claim 6, wherein the availability information comprises a moment or time period during which there is a highest probability to be available for a specific entity.

9. An apparatus according to claim 1, wherein the specific resource is at least one of a throughput, a processing power, a memory or a bandwidth.

10. An apparatus according to claim 1, wherein the first entity is a user side entity.

11. An apparatus according to claim 1, wherein the first entity is a network side entity.

12. An apparatus according to claim 1, wherein the second entity is a network side entity.

13. An apparatus according to claim 1, wherein the network slice comprises a mobile broadband slice, massive Internet of things slice, mission critical internet of things slice and/or one or more other slices.

14. An apparatus according to claim 1, wherein the request for availability information is sent to the second entity subsequently to the creation of the network slice.

15. An apparatus according to claim 14, wherein the request for availability information is received by the second entity subsequently to the creation of the specific network slice.

16. A method comprising:
determining that availability information relating to (i) a specific resource associated with a specific network slice, (ii) a specific resource associated with a specific subnetwork and a specific network slice or (iii) a specific resource associated with a specific service and a specific network slice is to be requested by a first entity; and
causing a request for availability information to be sent by the first entity to a second entity.

17. A method comprising:
receiving a request for availability information relating to (i) a specific resource associated with a specific network slice, (ii) a specific resource associated with a specific subnetwork and a specific network slice or (iii) a specific resource associated with a specific service and a specific network slice by a second entity from a first entity; and
causing a response with availability information to be sent by the second entity to the first entity.

18. A non-transitory computer readable medium comprising program instructions which when run on one or more processors perform the method of claim 16.

19. A non-transitory computer readable medium comprising program instructions which when run on one or more processors perform the method of claim 17.
